(19) United States
(12) Patent Application Publication
(10) Pub. No.: US 2012/0099512 A1
(43) Pub. Date: Apr. 26, 2012

(54) RADIO COMMUNICATION SYSTEM, RADIO BASE STATION, AND RADIO COMMUNICATION METHOD

(75) Inventor: Chiharu Yamazaki, Kanagawa (JP)

(73) Assignee: KYOCERA CORPORATION, Kyoto (JP)

(21) Appl. No.: 13/379,577

(22) PCT Filed: Jun. 25, 2010
(86) PCT No.: PCT/JP2010/060910

§ 371 Date: Dec. 20, 2011

(30) Foreign Application Priority Data
Jun. 25, 2009 (JP) 2009-151663

(51) Int. Cl. H04W 4/06

(52) U.S. Cl. 370/312

(57) ABSTRACT

A radio communication system (1) wherein a radio base station (BS1), which allocates to a radio terminal (UE1) a radio resource specified by the combination of a frequency and a time, and a radio base station (BS2), which allocates to the radio terminal (UE1) the same radio resource, use this radio resource to perform a cooperative communication with the radio terminal (UE1). In the radio communication system (1), if a predetermined condition, which indicates that the status of the communication between the radio base station (BS2) and the radio terminal (UE1) is good, is satisfied and further if a propagation path quality (Q2) between the radio base station (BS1) and a radio terminal (UE2) is better than a propagation path quality (Q1) between the radio base station (BS1) and the radio terminal (UE1), then the radio base station (BS1) allocates the foregoing radio resource to the radio terminal (UE2) instead of the radio terminal (UE1).

### TECHNICAL FIELD

The present invention relates to a radio communication system in which multiple radio base stations communicate with a single radio terminal while using the same radio resource, and also relates to a radio base station and a radio communication method.

### BACKGROUND ART

One of known conventional techniques capable of improving the frequency usage efficiency in a radio communication system is MIMO (Multi-Input Multi-Output) communications in which a transmission side transmits and a reception side receives radio signals by using the same radio resource (combination of frequency and time) while each using multiple antennas.

In recent years, coordinated MIMO communications (hereinafter, referred to as “coordinated communications” as needed) have been attracting attention as an advanced technique of MIMO communications. In the coordinated communications, multiple radio base stations make use of communications between the base stations to communicate with a single radio terminal by using the same radio resource (refer to Patent Document 1, for example). The 3GPP (3rd Generation Partnership Project), which is a standardization project for radio communication systems, has termed the above described coordinated communications CoMP (Coordinated Multipoint transmission/reception), and has been making discussion on the formulation of the specification of CoMP.

As a CoMP scheme, there is a scheme termed a JP (Joint Processing) scheme. The JP scheme is a coordinated communication scheme in which multiple radio base stations communicate with a radio terminal at the same time. A first radio base station and a second radio base station perform data transmission to a single radio terminal by using the same radio resource, for example. In coordinated communications of the JP scheme, the data transmitted by the first radio base station and the data transmitted by the second radio base station are basically the same data, and the radio terminal combines the data upon reception of the data.

### PRIOR ART DOCUMENT

### Patent Document

PATENT DOCUMENT 1: Published Japanese Translation of PCT International Application No. 2008-523665

### SUMMARY OF THE INVENTION

The coordinated communications (CoMP) can improve the communication performance as compared with normal MIMO communications, but achieves lower frequency usage efficiency than the normal MIMO communications because the radio resource is consumed by both of the first radio base station and the second radio base station. Furthermore, the coordinated communications of the JP scheme have the following problem.

To put it specifically, in the coordinated communications of the JP scheme, the effect of the improvement in the communication performance by the coordinated communications is small when the channel quality between the second radio base station and the radio terminal is high. In particular, in a radio communication system supporting adaptive modulation in which an MCS (combination of a modulation level and a code rate) is changeable depending on the channel quality, the throughput plateaus at a level determined by an MCS that satisfies a required throughput or the maximum MCS when the channel quality between the second radio base station and the radio terminal is high.

In such case, there is a problem that the radio resource used in coordinated communications by the first radio base station is wastefully consumed because a sufficient throughput can be obtained with the second radio base station alone.

In this respect, an object of the present invention is to provide a radio communication system, a radio base station and a radio communication method each of which achieves effective utilization for a radio resource used in coordinated communications.

The present invention has the following features to solve the problems described above. First of all, a first feature of the present invention is summarized as a radio communication system (radio communication system 1) comprising: a first radio terminal (radio terminal UE1); a second radio terminal (radio terminal UE2); a first radio base station (radio base station BS1) configured to allocate, to the first radio terminal, a radio resource (radio resource R1) specified by a combination of frequency and time; and a second radio base station (radio base station BS2) configured to allocate, to the first radio terminal, the same radio resource as the radio resource, wherein the first radio base station and the second radio base station perform coordinated communications (CoMP) with the first radio terminal by using the radio resource, and the first radio base station allocates the radio resource to the second radio terminal instead of the first radio terminal if a predetermined condition indicating that a communication state between the second radio base station and the first radio terminal is favorable is satisfied and also if a second channel quality (channel quality Q2) between the first radio base station and the second radio terminal is higher than a first channel quality (channel quality Q1) between the first radio base station and the first radio terminal.

According to the aforementioned feature, the first radio base station allocates the radio resource used in coordinated communications to the second radio terminal instead of the first radio terminal if the communication state between the second radio base station and the first radio terminal is favorable and also if the second channel quality is higher than the first channel quality. Thus, the radio resource can be effectively utilized.

Note that, if the first radio base station allocates the radio resource to the second radio terminal, the first radio terminal cannot perform communications with the first radio base station temporarily, but such a situation does not become a problem because the communication state between the second radio base station and the first radio terminal is favorable, and the second radio base station can communicate with the first radio terminal.

A second feature of the present invention is summarized as a radio base station (radio base station BS1) comprising a resource allocation unit (resource allocation unit 121) configured to allocate a radio resource specified by a combination of frequency and time to a radio terminal (radio terminal UE1), the radio base station configured to perform coordinated communications with the radio terminal together with a different radio base station (radio base station BS2) configured to allocate the same radio resource as the radio resource to the radio terminal, wherein the resource allocation unit allocates the radio resource to a different radio terminal (radio terminal UE2) instead of the radio terminal if a predetermined condition indicating that a communication state between the different radio base station and the radio terminal is favorable is satisfied and also if a second channel quality (channel quality Q2) between the radio base station and the different radio terminal is higher than a first channel quality (channel quality Q1) between the radio base station and the radio terminal.

In the aforementioned feature of the present invention, the predetermined condition may be that a third channel quality between the different radio base station and the radio terminal is higher than a predetermined quality.

In the aforementioned feature of the present invention, adaptive modulation in which an MCS (Modulation and Coding Scheme) is changeable on the basis of a third channel quality between the different radio base station and the radio terminal is employed for communications between the different radio base station and the radio terminal, and the predetermined condition may be that the MCS used in communications between the different radio base station and the radio terminal is a specific MCS.

In the aforementioned feature of the present invention, the specific MCS may be an MCS having the highest throughput among all MCSes usable in the adaptive modulation.

In the aforementioned feature of the present invention, the specific MCS may be an MCS satisfying a throughput required for communications between the different radio base station and the radio terminal among all MCSes usable in the adaptive modulation.

In the aforementioned feature of the present invention, if the MCS to be used in communications between the different radio base station and the radio terminal is previously set at the start of the communications between the different radio base station and the radio terminal, the specific MCS may be the set MCS.

In the aforementioned feature of the present invention, the resource allocation unit may allocate the radio resource to the radio terminal again if the predetermined condition is no longer satisfied.

In the aforementioned feature of the present invention, the radio base station may further comprise a transmitter (transceiver 110) configured to perform data transmission by using the radio resource; and a transmission power controller (transmission power controller 124) configured to control a transmission power for data transmission performed by the transmitter, wherein the resource allocation unit allocates the radio resource to the different radio terminal instead of the radio terminal if the predetermined condition is satisfied, if the second channel quality is higher than the first channel quality, and also if a difference between the first channel quality and the second channel quality is equal to or greater than a predetermined value (predetermined threshold) (Q1<<Q2), and the transmission power controller reduces a transmission power for data transmission to the different radio terminal below a transmission power for data transmission to the radio terminal if the resource allocation unit allocates the radio resource to the different radio terminal instead of the radio terminal.

In the aforementioned feature of the present invention, the resource allocation unit may allocate the radio resource to the different radio terminal instead of the radio terminal without taking a procedure to cancel the coordinated communications if the predetermined condition is satisfied and also if the second channel quality is higher than the first channel quality.

A third feature of the present invention is summarized as a radio communication method comprising the steps of: allocating a radio resource specified by a combination of frequency and time to a first radio terminal by a first radio base station; allocating the same radio resource as the radio resource to the first radio terminal by a second radio base station; performing coordinated communications with the first radio terminal by using the radio resource by the first radio base station and the second radio base station; and allocating the radio resource to the second radio terminal instead of the first radio terminal by the first radio base station if a predetermined condition indicating that a communication state between the second radio base station and the first radio terminal is favorable is satisfied and also if a second channel quality between the first radio base station and the second radio terminal is higher than a first channel quality between the first radio base station and the first radio terminal.

According to the features of the present invention, it is possible to provide the radio communication system, the radio base station and the radio communication method each of which makes it possible to effectively utilize a radio resource used in coordinated communications.

### BRIEF DESCRIPTION OF THE DRAWINGS

FIG. 1 is a schematic configuration diagram of a radio communication system according to a first embodiment and a second embodiment of the present invention.

FIG. 2 is a block diagram showing a configuration of a radio base station according to the first embodiment and the second embodiment of the present invention.

FIG. 3 is a flowchart showing a schematic operation of the radio communication system according to the first embodiment of the present invention.

FIG. 4 is a sequence diagram showing an operation sequence example 1 of the radio communication system according to the first embodiment of the present invention.

FIG. 5 is a sequence diagram showing an operation sequence example 2 of the radio communication system according to the first embodiment of the present invention.

FIG. 6 is a sequence diagram showing an operation sequence example 3 of the radio communication system according to the first embodiment of the present invention.

FIG. 7 is a flowchart showing a schematic operation of the radio communication system according to the second embodiment of the present invention.

FIG. 8 is a block diagram showing a configuration of a controller according to another embodiment.

### DESCRIPTION OF THE EMBODIMENTS

Next, a description will be given of a first embodiment, a second embodiment, and other embodiments of the present invention with reference to the drawings. Note that, in the description of the drawings of the following embodiments, same or similar reference signs denote same or similar elements and portions.

### First Embodiment

Hereinafter, a description will be given of a radio communication system according to the first embodiment of the present invention with reference to the drawings. To put it more specifically, a description will be given of (1) Configuration of Radio Communication System, (2) Configuration of Radio Base Station, (3) Operation of Radio Communication System, and (4) Effects of First Embodiment.

### (1) Configuration of Radio Communication System

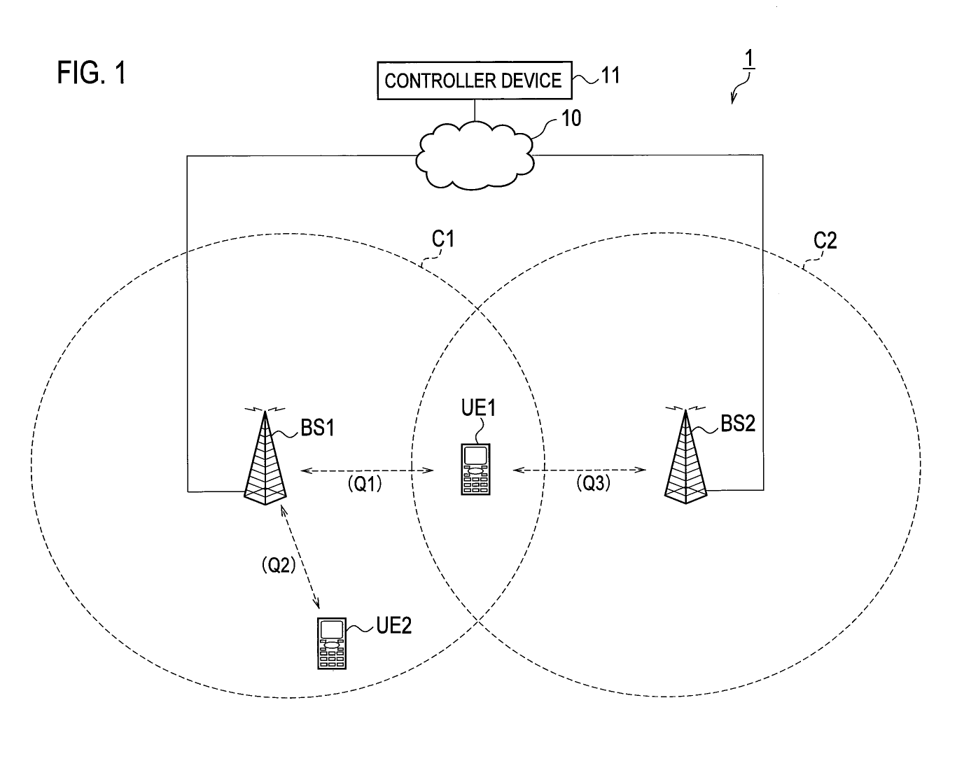

FIG. 1 is a schematic configuration diagram of a radio communication system 1 according to the first embodiment. The radio communication system 1 has a configuration based on LTE-Advanced, which is considered as the fourth generation (4G) cellular phone system, and supports CoMP (Coordinated Communications).

As shown in FIG. 1, the radio communication system 1 includes a radio base station BS1 (first radio base station), a radio base station BS2 (second radio base station), a radio terminal UE1 (first radio terminal), a radio terminal UE2 (second radio terminal) and a controller device 11.

The radio terminal UE1 is located in an overlapping portion of a cell C1, which is a communication area formed by the radio base station BS1, and a cell C2, which is a communication area formed by the radio base station BS2. The radio terminal UE2 is located within the cell C1.

The radio base station BS1, the radio base station BS2, the radio terminal UE1 and the radio terminal UE2 are each capable of periodically transmitting (broadcasting) a known signal that is a signal sequence known to the reception side (so called, a pilot signal). In addition, the radio base station BS1, the radio base station BS2, the radio terminal UE1 and the radio terminal UE2 are each capable of measuring channel qualities with the transmission side by using the received pilot signal. The channel qualities herein mean various parameters indicating the qualities of the radio channel such as the amounts of attenuation, phase rotation, and delay received by a signal passing through the radio channel. In the radio communication system 1, a channel quality Q1 between the radio base station BS1 and the radio terminal UE1, a channel quality Q2 between the radio base station BS1 and the radio terminal UE2, and a channel quality Q3 between the radio base station BS2 and the radio terminal UE1 are measured. Each of the channel qualities to be measured may be an instant channel quality or an average channel quality in a short period.

The radio base station BS1 and the radio base station BS2 are connected to each other via a backhaul network 10, which is a wired communication network. The controller device 11 is provided in the backhaul network 10 and controls the radio base station BS1 and the radio base station BS2 via the backhaul network 10. The radio base station BS1 and the radio base station BS2, however, are capable of directly performing communications between the base stations without the controller device 11 via a communication connection referred to as X2 interface.

The radio base station BS1 allocates a radio resource (hereinafter, a radio resource R1) specified by a combination of a frequency (subchannel) and time (time slot) to the radio terminal UE1. The radio resource R1 as described is referred to as a resource block (RB). The radio base station BS2 allocates the radio resource R1 to the radio terminal UE1. The radio base station BS1 and the radio base station BS2 perform. CoMP with the radio terminal UE1 by using the radio resource R1 allocated to the radio terminal UE1.

In CoMP of the JP scheme, the data transmitted by the radio base station BS1 using the radio resource R1 and the data transmitted by the radio base station BS2 using the radio resource R1 are basically the same data. To put it specifically, the reception quality in the radio terminal UE1 is improved by combining the data transmitted from the radio base station BS1 and the data transmitted from the radio base station BS2 by the radio terminal UE1.

### (2) Configuration of Radio Base Station

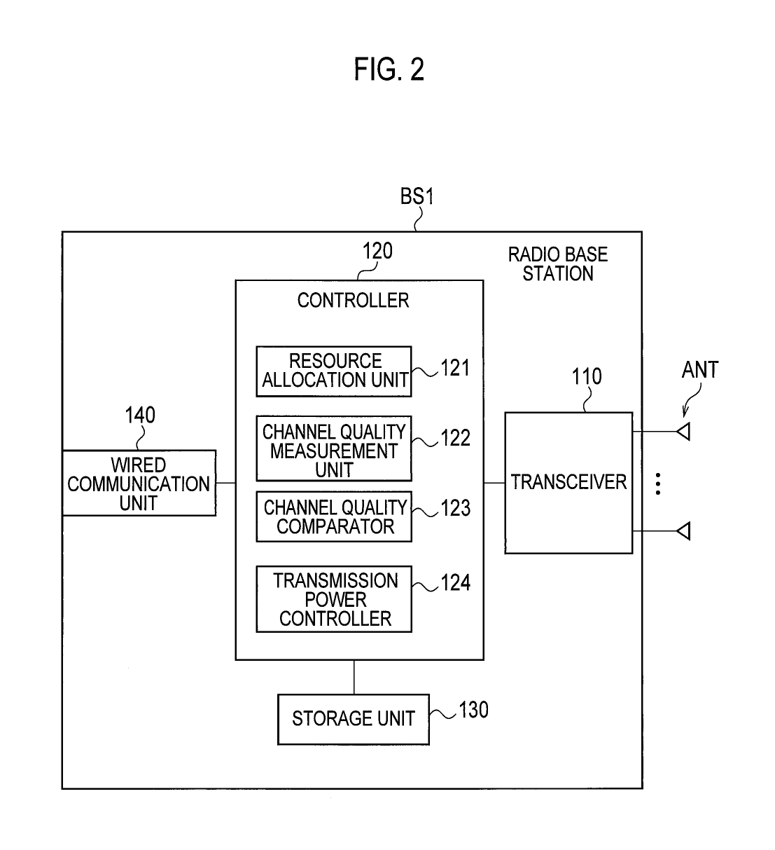

FIG. 2 is a block diagram showing a configuration of the radio base station BS1. As shown in FIG. 2, the radio base station BS1 includes antenna units ANT, a transceiver 110, a controller 120, a storage unit 130 and a wired communication unit 140.

The transceiver 110 is configured using an RF circuit, a BB circuit and the like, for example, and performs transmission and reception of a signal, as well as modulation/demodulation and coding/decoding or the like of a signal. The transceiver 110 forms a transmitter configured to perform data transmission by using the radio resource R1.

The controller 120 is configured using a CPU, for example, and controls various functions included in the radio base station BS1. The storage unit 130 is configured using a memory, for example, and stores therein various types of information used in control or the like of the radio base station BS1. The wired communication unit 140 communicates with the radio base station BS2 and the controller device 11 via the backhaul network 10.

The controller 120 has a resource allocation unit 121, a channel quality measurement unit 122, a channel quality comparator 123 and a transmission power controller 124.

The resource allocation unit 121 allocates the radio resource R1 to the radio terminal UE1 when CoMP is performed with the radio terminal UE1.

The channel quality measurement unit 122 measures the channel quality Q1 by using a pilot signal 1 received from the radio terminal UE1 and also measures the channel quality Q2 by using a pilot signal 2 received from the radio terminal UE2.

The channel quality comparator 123 compares the channel quality Q1 and the channel quality Q2, which are measured by the channel quality measurement unit 122, and then compares a difference between the channel quality Q1 and the channel quality Q2 with a predetermined value (predetermined threshold).

The resource allocation unit 121 allocates the radio resource R1 to the radio terminal UE2 instead of the radio terminal UE1 if a predetermined condition indicating that the communication state between the radio base station BS2 and the radio terminal UE1 is favorable is satisfied and also if the channel quality Q2 is higher than the channel quality Q1 (hereinafter, described as the channel quality Q1<the channel quality Q2). As a condition for allocating the radio resource R1 to the radio terminal UE2 instead of the radio terminal UE1, the resource allocation unit 121 preferably uses a condition that the channel quality Q2 is higher than the channel quality Q1 by an amount equal to or greater than a predetermined threshold (hereinafter, described as the channel quality Q1<<the channel quality Q2) instead of using the condition that the channel quality Q1<the channel quality Q2. Note that, the allocation of the radio resource R1 to the radio terminal UE2 is performed without taking the procedure to cancel CoMP.

Here, in the first embodiment, the predetermined condition is that the channel quality Q3 is higher than a predetermined quality (hereinafter, described as the predetermined quality<the channel quality Q3). Note that, the lower limit of the predetermined quality may be set as a channel quality of a case where the radio terminal UE1 is capable of demodulating data by using a transmission signal from the radio base station BS2 alone. The predetermined quality may be previously stored in the storage unit 130.

The transmission power controller 124 controls a transmission power for data transmission performed by the transceiver 110. In a case where the resource allocation unit 121 allocates the radio resource R1 to the radio terminal UE2 instead of the radio terminal UE1, the transmission power controller 124 reduces the transmission power for data transmission to the radio terminal UE2 below the transmission power for data transmission to the radio terminal UE1.

The resource allocation unit 121 allocates the radio resource R1 to the radio terminal UE1 again if the predetermined condition described above is no longer satisfied after the radio resource R1 is allocated to the radio terminal UE2.

### (3) Operation of Radio Communication System

Next, a description will be given of an operation of the radio communication system 1 according to the first embodiment in the order of (3.1) Schematic Operation and (3.2) Operation Sequence Examples.

### (3.1) SCHEMATIC OPERATION

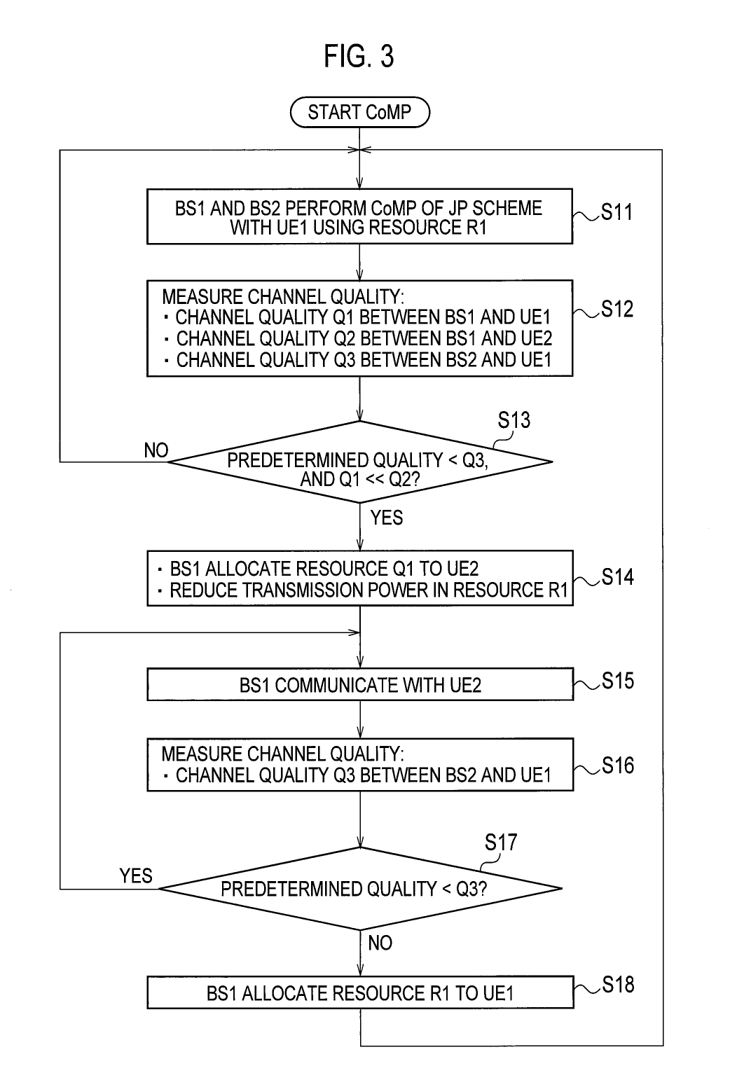

FIG. 3 is a flowchart showing a schematic operation of the radio communication system 1. First, the controller device 11, the radio base station BS1, the radio base station BS2 and the radio terminal UE1 perform a setting procedure for starting CoMP. Here, an assumption is made that it is determined to use the radio resource R1 in CoMP in this setting procedure.

In step S11, the radio base station BS1 and the radio base station BS2 perform CoMP of the JP scheme with the radio terminal UE1 by using the radio resource R1.

In step S12, the radio base station BS1 or the radio terminal UE1 measures the channel quality Q1 between the radio base station BS1 and the radio terminal UE1. The radio base station BS1 or the radio terminal UE2 measures the channel quality Q2 between the radio base station BS1 and the radio terminal UE2. The radio base station BS2 or the radio terminal UE1 measures the channel quality Q3 between the radio base station BS2 and the radio terminal UE1.

In step S13, the radio base station BS1 compares the channel quality Q1 with the channel quality Q2 and also compares a difference between the channel quality Q1 and the channel quality Q2 with a predetermined threshold. The controller device 11 or the radio base station BS1 compares the channel quality Q3 with a predetermined quality.

In a case where the predetermined quality<the channel quality Q3 and the channel quality Q1<<the channel quality Q2 (step S13; YES), the radio base station BS1 allocates the radio resource R1 to the radio terminal UE2 instead of the radio terminal UE1 in step S14. In addition, the radio base station BS1 reduces the transmission power in the radio resource R1. Meanwhile, if at least one of the predetermined quality<the channel quality Q3 and the channel quality Q1<<the channel quality Q2 is not satisfied (step S13; NO), the processing returns to step S11.

In step S15, the radio base station BS1 communicates with the radio terminal UE2 by using the radio resource R1 allocated to the radio terminal UE2.

In step S16, the radio base station BS2 or the radio terminal UE1 measures the channel quality Q3 between the radio base station BS2 and the radio terminal UE1.

In a case where the channel quality Q3 measured in step S16 no longer satisfies the condition that the predetermined quality<the channel quality Q3 (step S17; NO), the radio base station BS1 allocates the radio resource R1 to the radio terminal UE1 again in step S18. Meanwhile, if the condition that the predetermined quality<the channel quality Q3 is satisfied (step S17; YES), the processing returns to step S15.

### (3.2) OPERATION SEQUENCE EXAMPLES

Next, a description will be given of operation sequence examples 1 to 3 of the radio communication system 1 according to the first embodiment. However, it is to be noted that each operation sequence to be described below is merely an example, and that various modifications can be made.

### (3.2.1) Operation Sequence Example 1

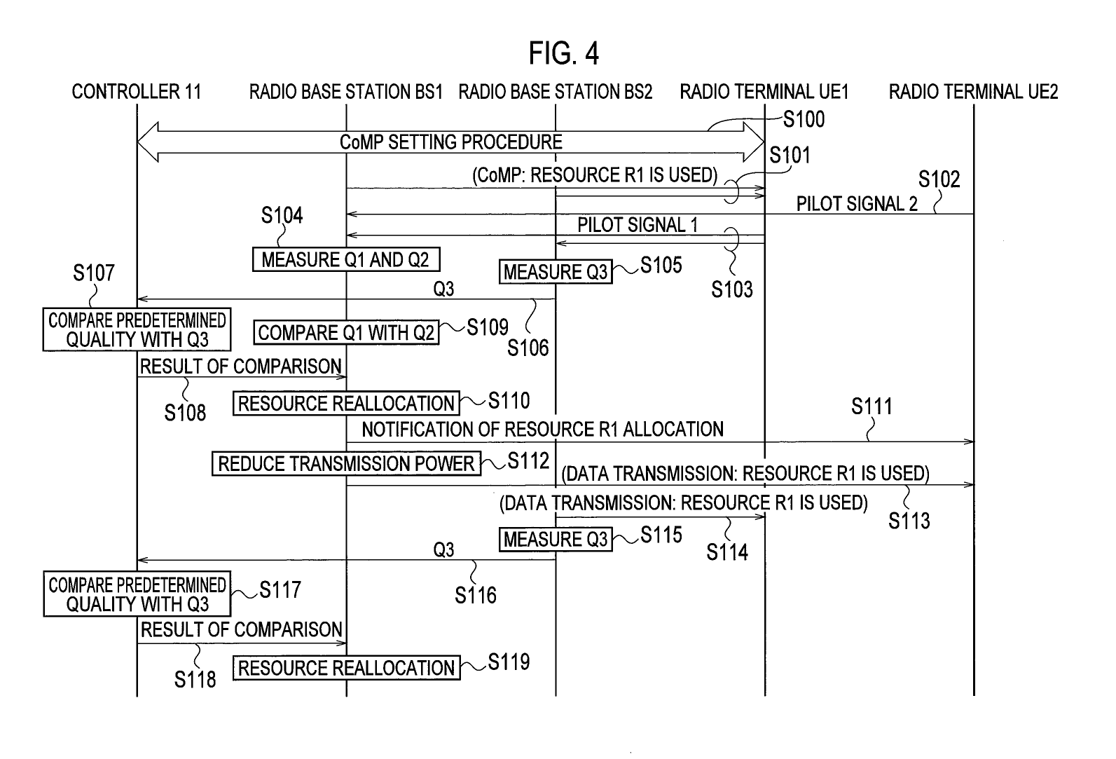

FIG. 4 is a sequence diagram showing an operation sequence example 1 of the radio communication system 1.

In step S100, the controller device 11, the radio base station BS1, the radio base station BS2 and the radio terminal UE1 perform a setting procedure for starting CoMP.

In step S101, the radio base station BS1 and the radio base station BS2 perform CoMP with the radio terminal UE1 by using the radio resource R1.

In step S102, the radio terminal UE2 transmits a pilot signal 2. In step S103, the radio terminal UE1 transmits a pilot signal 1. Note that, each pilot signal is periodically transmitted thereafter.

In step S104, the channel quality measurement unit 122 of the radio base station BS1 measures the channel quality Q1 from the pilot signal 1 received from the radio terminal UE1 and also measures the channel quality Q2 from the pilot signal 2 received from the radio terminal UE2.

In step S105, the radio base station BS2 measures the channel quality Q3 from the pilot signal 1 received from the radio terminal UE1.

In step S106, the radio base station BS2 transmits the channel quality Q3 measured in step S105 (or an index of the channel quality Q3) to the controller device 11.

In step S107, the controller device 11 compares a predetermined quality with the channel quality Q3 received from the radio base station BS2 in step S106. In this operation example, an assumption is made that the result of the comparison shows that the predetermined quality<the channel quality Q3.

In step S108, the controller device 11 transmits information showing the result of the comparison between the predetermined quality and the channel quality Q3 to the radio base station BS1.

In step S109, the channel quality comparator 123 of the radio base station BS1 compares the channel quality Q1 and the channel quality Q2, which are measured by the channel quality measurement unit 122. In this operation example, an assumption is made that the result of the comparison shows that the channel quality Q1<<the channel quality Q2.

In step S110, the resource allocation unit 121 of the radio base station BS1 allocates the radio resource R1 to the radio terminal UE2. During this processing, the procedure to cancel CoMP is omitted, and CoMP is kept set.

In step S111, the transceiver 110 of the radio base station BS1 transmits to the radio terminal UE2, an allocation notification indicating allocation of the radio resource R1.

In step S112, the transmission power controller 124 of the radio base station BS1 performs control to reduce the transmission power of the transmission signal using the radio resource R1.

In step S113, the transceiver 110 of the radio base station BS1 performs data transmission to the radio terminal UE2 by using the radio resource R1 allocated to the radio terminal UE2.

In step S114, the radio base station BS2 performs data transmission to the radio terminal UE1 by using the radio resource R1.

In step S115, the radio base station BS2 again measures the channel quality Q3 from the pilot signal 1 newly received from the radio terminal UE1.

In step S116, the radio base station BS2 transmits the channel quality Q3 measured in step S115 (or an index of the channel quality Q3) to the controller device 11.

In step S117, the controller device 11 compares a predetermined quality with the channel quality Q3 received from the radio base station BS2. In this operation example, an assumption is made that the result of the comparison shows that the predetermined quality>the channel quality Q3.

In step S118, the controller device 11 transmits information showing the result of the comparison between the predetermined quality and the channel quality Q3 to the radio base station BS1.

In step S122, the resource allocation unit 121 of the radio base station BS1 allocates the radio resource R1 to the radio terminal UE1 again. Note that, since the procedure to cancel CoMP is omitted, it is unnecessary to perform the setting procedure for resetting CoMP.

### (3.2.2) Operation Sequence Example 2

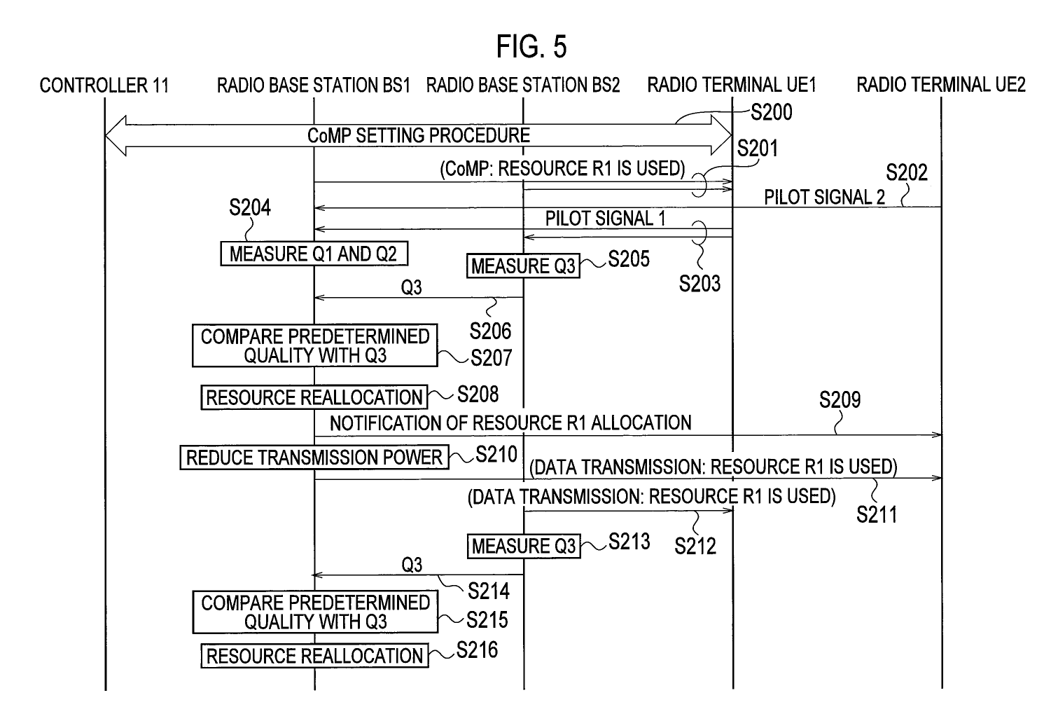

FIG. 5 is a sequence diagram showing an operation sequence example 2 of the radio communication system 1. While the controller device 11 performs the comparison between the predetermined quality and the channel quality Q3 in the operation sequence example 1 described above, the radio base station BS1 performs this comparison in this operation example.

The processing in steps S200 to S205 is executed in the same manner as in the case of steps S100 to S105 in the operation sequence example 1 described above.

In step S206, the radio base station BS2 transmits the channel quality Q3 measured in step S205 (or an index of the channel quality Q3) to the radio base station BS1 through the communications between the base stations.

In step S207, the channel quality comparator 123 of the radio base station BS1 compares the channel quality Q1 and the channel quality Q2, which are measured in step S204. In this operation example, an assumption is made that the result of the comparison shows that the channel quality Q1<<the channel quality Q2. The resource allocation unit 121 compares the predetermined quality with the channel quality Q3 received from the radio base station BS2 in step S106. In this operation example, an assumption is made that the result of the comparison shows that the predetermined quality<the channel quality Q3.

In step S208, the resource allocation unit 121 of the radio base station BS1 allocates the radio resource R1 to the radio terminal UE2. During this processing, the procedure to cancel CoMP is omitted, and CoMP is kept set.

In step S209, the transceiver 110 of the radio base station BS1 transmits to the radio terminal UE2, an allocation notification indicating allocation of the radio resource R1.

In step S210, the transmission power controller 124 of the radio base station BS1 performs control to reduce the transmission power of the transmission signal using the radio resource R1.

In step S211, the transceiver 110 of the radio base station BS1 performs data transmission to the radio terminal UE2 by using the radio resource R1 allocated to the radio terminal UE2.

In step S212, the radio base station BS2 performs data transmission to the radio terminal UE1 by using the radio resource R1.

In step S213, the radio base station BS2 again measures the channel quality Q3 from the pilot signal 1 newly received from the radio terminal UE1.

In step S214, the radio base station BS2 transmits the channel quality Q3 measured in step S115 (or an index of the channel quality Q3) to the radio base station BS1 through the communications between base stations.

In step S215, the resource allocation unit 121 of the radio base station BS1 compares a predetermined quality with the channel quality Q3 received from the radio base station BS2 in step S214. In this operation example, an assumption is made that the result of the comparison shows that the predetermined quality>the channel quality Q3.

In step S216, the resource allocation unit 121 of the radio base station BS1 allocates the radio resource R1 to the radio terminal UE1 again. Note that, since the procedure to cancel CoMP is omitted, it is unnecessary to perform the setting procedure for resetting CoMP.

As described above, according to this operation sequence, it is made possible to perform reallocation of the radio resource R1 without relying on the controller device 11.

### (3.2.3) Operation Sequence Example 3

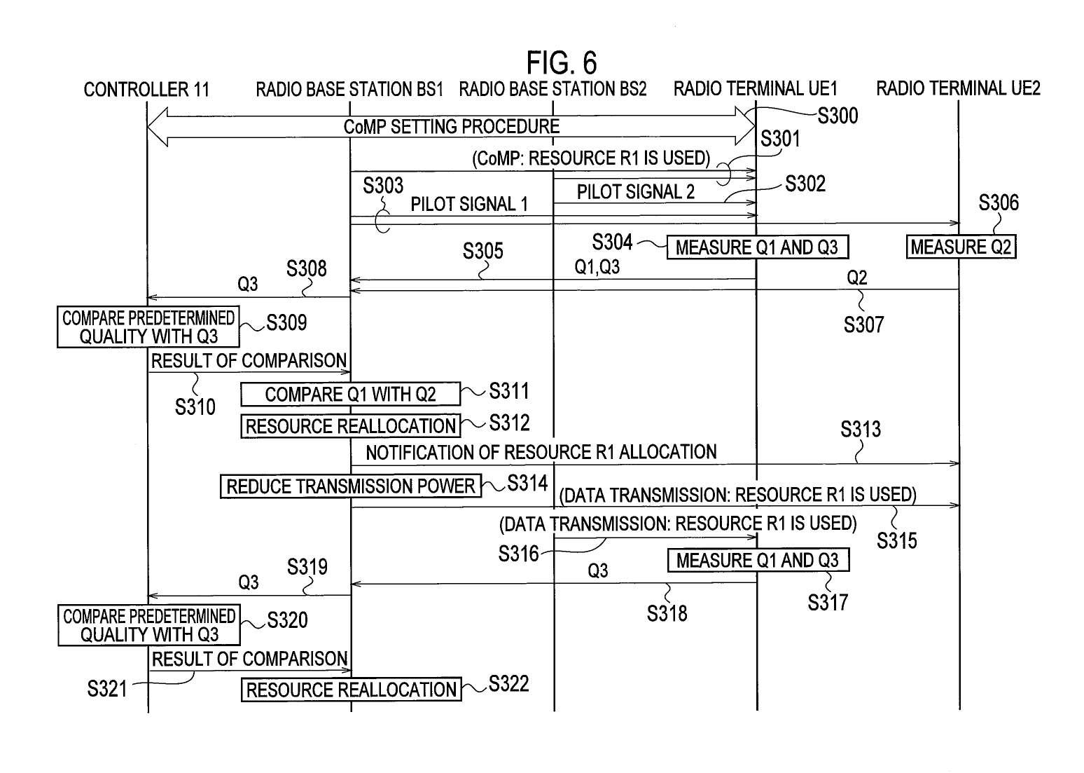

FIG. 6 is a sequence diagram showing an operation sequence example 3 of the radio communication system 1. While the radio base station BS1 and the radio base station BS2 measure the channel quality in the operation sequence examples 1 and 2 described above, the radio terminal UE1 and the radio terminal UE2 perform this measurement in this operation example.

The processing in steps S300 and 301 is executed in the same manner as in the case of steps S100 and S101 in the operation sequence example 1 described above.

In step S302, the radio base station BS2 transmits the pilot signal 2. In step S303, the base station BS1 transmits the pilot signal 1. Note that, each pilot signal is periodically transmitted thereafter.

In step S304, the radio terminal UE1 measures the channel quality Q1 from the pilot signal 1 received from the radio base station BS1 and also measures the channel quality Q3 from the pilot signal 2 received from the radio base station BS2.

In step S305, the radio terminal UE1 transmits the channel quality Q1 and the channel quality Q3 (or index thereof), which are measured in step S304, to the radio base station BS1.

In step S306, the radio terminal UE2 measures the channel quality Q2 from the pilot signal 1 received from the radio base station BS1.

In step S307, the radio terminal UE2 transmits the channel quality Q2 measured in step S306 (or an index of the channel quality Q2) to the radio base station BS1.

In step S308, the transceiver 110 of the radio base station BS1 transmits the channel quality Q3 received from the radio terminal UE1 in step S305 (or an index of the channel quality Q3) to the controller device 11.

In step S309, the controller device 11 compares a predetermined quality with the channel quality Q3 received from the radio base station BS2 in step S308. In this operation example, an assumption is made that the result of the comparison shows that the predetermined quality<the channel quality Q3.

In step S310, the controller device 11 transmits information showing the result of the comparison between the predetermined quality and the channel quality Q3 to the radio base station BS1.

In step S311, the channel quality comparator 123 of the radio base station BS1 compares the channel quality Q1 received in step S305 and the channel quality Q2 received in step S307. In this operation example, an assumption is made that the result of the comparison shows that the channel quality Q1<<the channel quality Q2.

In step S312, the resource allocation unit 121 of the radio base station BS1 allocates the radio resource R1 to the radio terminal UE2. During this processing, the procedure to cancel CoMP is omitted, and CoMP is kept set.

In step S313, the transceiver 110 of the radio base station BS1 transmits to the radio terminal UE2, an allocation notification indicating allocation of the radio resource R1.

In step S314, the transmission power controller 124 of the radio base station BS1 performs control to reduce the transmission power of the transmission signal using the radio resource R1.

In step S315, the transceiver 110 of the radio base station BS1 performs data transmission to the radio terminal UE2 by using the radio resource R1 allocated to the radio terminal UE2.

In step S316, the radio base station BS2 performs data transmission to the radio terminal UE1 by using the radio resource R1.

In step S317, the radio terminal UE1 again measures the channel quality Q3 from the pilot signal 2 newly received from the radio base station BS2.

In step S318, the radio terminal UE1 transmits the channel quality Q3 measured in step S317 (or an index of the channel quality Q3) to the radio base station BS1.

In step S319, the transceiver 110 of the radio base station BS1 transmits the channel quality Q3 received from the radio terminal UE1 in step S305 (or an index of the channel quality Q3) to the controller device 11.

In step S320, the controller device 11 compares a predetermined quality with the channel quality Q3 received from the radio base station BS2 in step S308. In this operation example, an assumption is made that the result of the comparison shows that the predetermined quality>the channel quality Q3.

In step S321, the controller device 11 transmits information showing the result of the comparison between the predetermined quality and the channel quality Q3 to the radio base station BS1.

In step S322, the resource allocation unit 121 of the radio base station BS1 allocates the radio resource R1 to the radio terminal UE1 again. Note that, since the procedure to cancel CoMP is omitted, it is unnecessary to perform the setting procedure for resetting CoMP.

As described above, according to this operation sequence, the channel quality of the downlink can be measured. Thus, the operation sequence is effective if the duplex operation is FDD.

### (4) Effects of First Embodiment

As described above, according to the first embodiment, the resource allocation unit 121 of the radio base station BS1 allocates the radio resource R1 used in CoMP to the radio terminal UE2 instead of the radio terminal UE1 without performing the procedure to cancel CoMP if the predetermined quality<the channel quality Q3 and also if the channel quality Q1<<the channel quality Q2 in CoMP of the JP scheme. Accordingly, the radio resource R1 can be effectively utilized.

For a period when the radio resource R1 is kept allocated to the radio terminal UE2 by the radio base station BS1, the radio terminal UE1 is in a state where data is supposed to be transmitted thereto from the radio base station BS1, and a transmission signal from the radio base station BS1 to the radio terminal UE2 directly acts as an interference signal to the radio terminal UE1.

Here, the resource allocation unit 121 of the radio base station BS1 allocates the radio resource R1 to the radio terminal UE2 having a higher channel quality than the radio terminal UE1. Thus, the transmission power to the radio terminal UE2 can be suppressed to be low.

For this reason, the transmission power controller 124 of the radio base station BS1 reduces the transmission power for data transmission to the radio terminal UE2 below the transmission power for data transmission to the radio terminal UE1 after the radio resource R1 is allocated to the radio terminal UE2.

Accordingly, the signal transmitted to the radio terminal UE2 from the radio base station BS1 seems sufficiently low in the radio terminal UE1. Thus, it is possible to reduce interference from the communications between the radio base station BS1 and the radio terminal UE2 to the communications between the radio base station BS2 and the radio terminal UE1.

Even if the signal supposed to be transmitted from the radio base station BS1 to the radio terminal UE1 becomes undetectable as a result of reducing the transmission power by the radio base station BS1, the radio terminal UE1 can modulate data from the transmission signal sent from the radio base station BS2 alone. Thus, there is no problem even in this case.

In addition, according to the first embodiment, the resource allocation unit 121 of the radio base station BS1 allocates the radio resource R1 used in CoMP to the radio terminal UE2 instead of the radio terminal UE1 without taking the procedure to cancel CoMP.

In a case where the condition that the predetermined quality<the channel quality Q3 no longer holds true in CoMP of the JP scheme, the resource allocation unit 121 of the radio base station BS1 allocates the radio resource R1 to the radio terminal UE1 again.

With the above described processing, it is made possible to temporarily allocate the radio resource R1 to the radio terminal UE2 without canceling CoMP. Thus, it is possible to avoid an increase in the processing load on the controller device 11 or the like associated with setting or cancellation of CoMP and also to avoid an increase in traffic in the backhaul network 10.

### Second Embodiment

Hereinafter, a description will be given of a radio communication system according to a second embodiment of the present invention in the order of (1) Configuration of Radio Communication System, (2) Configuration of Radio Base Station (3) Operation of Radio Communication System and (4) Effects of Second Embodiment. Here, a description will be given of only differences from the first embodiment, and an overlapping description will be omitted.

To put it specifically, while the predetermined condition is that the channel quality Q3 is higher than the predetermined quality in the first embodiment described above, the predetermined condition in the second embodiment is that an MCS (Modulation and Coding Scheme) used in communications between the radio base station BS2 and the radio terminal UE1 is a specific MCS. To put it more specifically, the predetermined condition in the second embodiment is that the channel quality Q3 between the radio base station BS2 and the radio terminal UE1 satisfies a quality required by the specific MCS.

### (1) Configuration of Radio Communication System

In the radio communication system 1, adaptive modulation in which an MCS specified by a combination of a modulation level and a code ratio is changeable is employed between the radio base station BS1 and the radio terminal UE1, and between the radio base station BS2 and the radio terminal UE1. The MCS used in communications between the radio base station BS1 and the radio terminal UE1 is changed on the basis of the channel quality Q1 between the radio base station BS1 and the radio terminal UE1. The MCS used in communications between the radio base station BS2 and the radio terminal UE1 is changed on the basis of the channel quality Q3 between the radio base station BS2 and the radio terminal UE1.

In the radio communication system 1 employing the adaptive modulation, multiple MCSes are previously defined, and any MCS selected from the multiple MCSes is used in the communications between the radio base station BS1 and the radio terminal UE1 and the communications between the radio base station BS2 and the radio terminal UE1. In the adaptive modulation, the modulation efficiency, which is the number of bits transmittable per symbol, is different for each of the MCSes. The higher modulation efficiency leads to the higher throughput but also leads to the lower error resilience. Meanwhile, the lower modulation efficiency leads to the higher error resilience but also leads to the lower throughput. Note that, the MCS is also referred to as an “MCS level” in LTE-Advanced.

### (2) Configuration of Radio Base Station

The predetermined condition in the second embodiment is that the MCS used in communications between the radio base station BS2 and the radio terminal UE1 is a specific MCS. The specific MCS is any of MCSes described in (a) to (c) below, for example. (a) MCS having the highest throughput among all the MCSes usable in adaptive modulation (hereinafter, described as the “best MCS”). (b) MCS satisfying a throughput required for the communications between the radio base station BS2 and the radio terminal UE1 (hereinafter, described as a “required throughput”) among all the MCSes usable in adaptive modulation. Here, the required throughput is determined depending on an application used by the radio terminal UE1 when the radio terminal UE1 communicates with the radio base station BS2. Each MCS that satisfies a required throughput of a VoIP application (small capacity), each MCS that satisfies a required throughput of a video streaming application (large capacity) and the like are previously defined, for example. To put it differently, the condition (b) adaptively determines the MCS for each subframe so as to satisfy the required throughput. (c) MCS set as the MCS to be used in communications between the radio terminal UE1 and the radio base station BS2 at the start of the communications between the radio terminal UE1 and the radio base station BS2. Here, the MCS set at the start of the communications between the radio terminal UE1 and the radio base station BS2 is determined depending on a required throughput of an application used by the radio terminal UE1 in communications with the radio base station BS2. To put it more specifically, the MCS required for the radio terminal UE1 is determined on the basis of the intervals of subframes and the number of resource blocks allocated by the radio base station BS2 to the radio terminal UE1 and the required throughput. To put it differently, the condition (c) is that allocation of an MCS used in the future in advance is reserved to satisfy the required throughput.

### (3) Operation of Radio Communication System

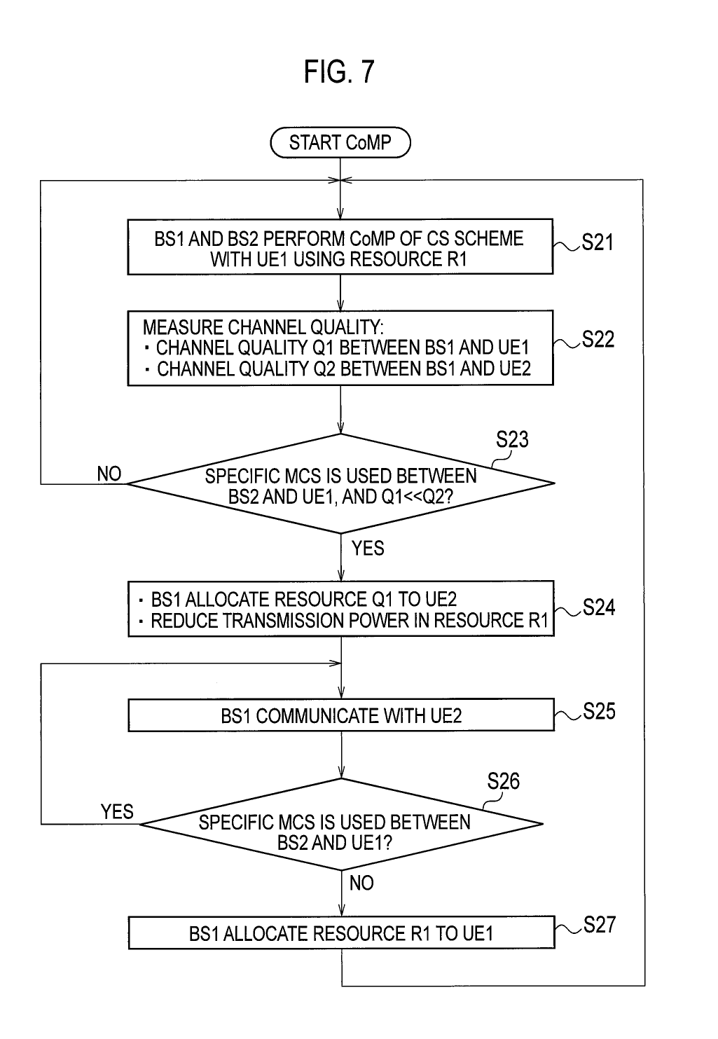

Next, a description will be given of an operation of the radio communication system 1 according to the second embodiment. FIG. 7 is a flowchart showing a schematic operation of the radio communication system 1 according to the second embodiment.

First, the controller device 11, the radio base station BS1, the radio base station BS2 and the radio terminal UE1 perform a setting procedure for starting CoMP. Here, an assumption is made that it is determined to use the radio resource R1 in CoMP in this setting procedure. In a case where the specific MCS is the above (b), an MCS that satisfies the required throughput is determined in this setting procedure depending on the application used by the radio terminal UE1. Meanwhile, if the specific MCS is the above (c), the MCS to be used in communications between the radio base station BS2 and the radio terminal UE1 is set in this setting procedure.

In step S21, the radio base station BS1 and the radio base station BS2 perform CoMP of the JP scheme with the radio terminal UE1 by using the radio resource R1.

In step S22, the radio base station BS1 or the radio terminal UE1 measures the channel quality Q1 between the radio base station BS1 and the radio terminal UE1. The radio base station BS1 or the radio terminal UE2 measures the channel quality Q2 between the radio base station BS1 and the radio terminal UE2.

In step S23, the radio base station BS1 compares the channel quality Q1 with the channel quality Q2 and also compares a difference between the channel quality Q1 and the channel quality Q2 with a predetermined threshold. The controller device 11 or the radio base station BS1 compares the MCS used in communications between the radio base station BS2 and the radio terminal UE1 with a specific MCS.

In a case where the MCS used in communications between the radio base station BS2 and the radio terminal UE1 is the specific MCS, and the channel quality Q1<<the channel quality Q2 (step S23; YES), the radio base station BS1 allocates the radio resource R1 to the radio terminal UE2 instead of the radio terminal UE1 in step S24. In addition, the radio base station BS1 reduces the transmission power in the radio resource R1. Meanwhile, if at least one of the conditions that the MCS used in communications between the radio base station BS2 and the radio terminal UE1 is the specific MCS and that the channel quality Q1<<the channel quality Q2 is not satisfied (step S23; NO), the processing returns to step S21.

In step S25, the radio base station BS1 communicates with the radio terminal UE2 by using the radio resource R1 allocated to the radio terminal UE2.

In step S26, the controller device 11 or the radio base station BS1 compares the MCS used in the communications between the radio base station BS2 and the radio terminal UE1 with the specific MCS.

In a case where the condition that the MCS used in the communications between the radio base station BS2 and the radio terminal UE1 is the specific MCS is no longer satisfied (step S26; NO), the radio base station BS1 allocates the radio resource R1 to the radio terminal UE1 again in step S27. Meanwhile, if the condition that the MCS used in the communications between the radio base station BS2 and the radio terminal UE1 is the specific MCS is satisfied (step S26; YES), the processing returns to step S25.

### (4) Effects of Second Embodiment

As described above, according to the second embodiment, the resource allocation unit 121 of the radio base station BS1 allocates the radio resource R1 used in CoMP to the radio terminal UE2 instead of the radio terminal UE1 without performing the procedure to cancel CoMP if the MCS used in communications between the radiobase station BS2 and the radio terminal UE1 is the specific MCS, and the channel quality Q1<<the channel quality Q2 in CoMP of the JP scheme. Accordingly, the radio resource R1 can be effectively utilized.

In the second embodiment, a sufficient throughput can be obtained by the radio base station BS2 alone if the MCS used in communications between the radio base station BS2 and the radio terminal UE1 is the best MCS, the MCS that satisfies the required throughput, or the MCS that is set as the MCS to be used in communications between the radio base station BS2 and the radio terminal UE1 when the communications between the radio base station BS2 and the radio terminal UE1 are started. Thus, the radio terminal UE1 can demodulate data by a transmission signal from the radio base station BS2 alone.

In particular, if the specific MCS is the above (b), the radio resource R1 can be allocated to the radio terminal UE2 instead of the radio terminal UE1 even if an MCS below the best MCS is used in communications between the radio base station BS2 and the radio terminal UE1. Accordingly, since the condition for allocating the radio resource R1 to the radio terminal UE2 instead of the radio terminal UE1 can be changed depending on the application used by the radio terminal UE1, the radio resource R1 can be effectively utilized in a more flexible manner.

### Other Embodiments

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily found by those skilled in the art.

### (1) Modification Example 1

In the first embodiment and the second embodiment described above, the case where the radio base station BS1, the radio base station BS2 and the radio terminal UE1 perform CoMP of the JP scheme is described. However, the scheme is not limited to the JP scheme, and the radio base station BS1, the radio base station BS2 and the radio terminal UE1 may perform CoMP of a CS (Coordinated Scheduling) scheme. The CS scheme is a coordinated communication scheme in which a radio base station having a high channel quality with a radio terminal among multiple radio base stations communicates with the radio terminal. The CS scheme is a scheme in which any one of the radio base station BS1 and the radio base station BS2, both using the same radio resource, selectively performs data transmission to the radio terminal, for example.

### (2) Modification Example 2

In the first embodiment described above, the controller device 11 or the radio base station BS1 compares the predetermined quality with the channel quality Q3. However, a device other than the controller device 11 or the radio base station BS1 (the radio terminal UE1 or the radio base station BS2, for example) may compare the predetermined quality with the channel quality Q3.

### (3) Modification Example 3

In the second embodiment described above, the controller device 11 or the radio base station BS1 compares the MCS used in communications between the radio base station BS2 and the radio terminal UE1 with the specific MCS. However, a device other than the controller device 11 or the radio base station BS1 (the radio terminal UE1 or the radio base station BS2, for example) may compare the MCS used in communications between the radio base station BS2 and the radio terminal UE1 with the specific MCS.

### (4) Modification Example 4

In the first embodiment and the second embodiment described above, the radio resource R1 is allocated to the radio terminal UE2 instead of the radio terminal UE1 if a predetermined condition indicating that the communication state between the radio base station BS2 and the radio terminal UE1 is favorable is satisfied and also if the channel quality Q1<<the channel quality Q2 holds true. However, the condition that the channel quality Q1<<the channel quality Q2 may be changed to a condition that the channel quality Q1<the channel quality Q2.

### (5) Modification Example 5

In the first embodiment and the second embodiment described above, the radio communication system 1 has a configuration based on LTE-Advanced, but the configuration is not limited to LTE-Advanced, and the present invention is applicable to any radio communication system supporting coordinated communications.

### (6) Modification Example 6

In the first embodiment and the second embodiment described above, the case where two radio base stations (the radio base station BS1 and the radio base station BS2) perform CoMP with the radio terminal UE1 is described. However, the present invention is not limited to this case, and three or more radio base stations including the radio base station BS1 may perform CoMP with the radio terminal UE1. In this case, the radio base station BS1 preferably allocates the radio resource R1 to the radio terminal UE2 instead of the radio terminal UE1 if a predetermined condition indicating that the communication state between at least one radio base station among multiple radio base stations other than the radio base station BS1 and the radio terminal UE1 is favorable is satisfied and also if the channel quality Q1<the channel quality Q2 holds true.

### (7) Modification Example 7

In the embodiments described above, the configuration in which each of the radio base station BS1 and the radio base station BS2 performs baseband (BB) processing is described, but it is also possible to employ a configuration in which the BB processing is performed by the controller device 11. The type of radio base station reduced in size by providing a portion performing BB processing outside is referred to as a remote radio head (RRH). The RRH is mainly configured of an antenna and a radio frequency (RF) circuit.

In a case where the radio base station BS1 and the radio base station BS2 are each configured of an RRH, the radio base station BS1 and the radio base station BS2 are each connected to the controller device 11 via an optical fiber line or the like. The controller device 11 transmits and receives a BB signal to and from each of the radio base station BS1 and the radio base station BS2 via the optical fiber line or the like.

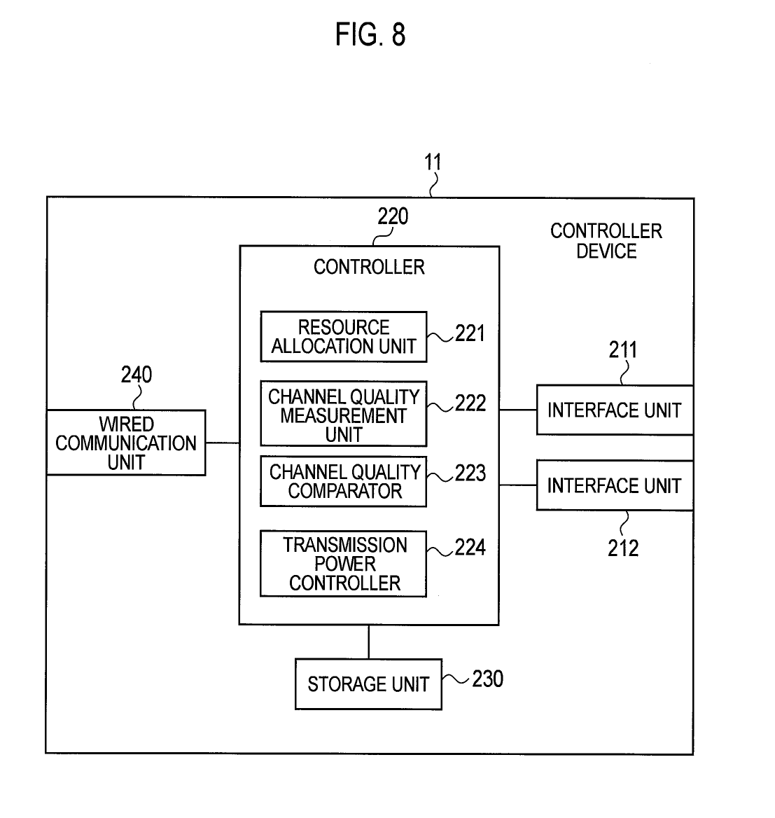

FIG. 8 is a block diagram showing the configuration of the controller device 11 in the case where the radio base station BS1 and the radio base station BS2 are each configured of an RRH. As shown in FIG. 8, the controller device 11 includes an interface unit 211, an interface unit 212, a controller 220, a storage unit 230 and a wired communication unit 240.

The interface unit 211 is configured using a BB circuit or the like and functions as an interface with the radio base station BS1. The interface unit 212 is configured using a BB circuit or the like and functions as an interface with the radio base station BS2.

The controller 220 is configured using a CPU, for example, and controls various functions included in the radio base station BS1, the radio base station BS2 and the controller device 11. The storage unit 230 is configured using a memory, for example, and stores therein various types of information used in control or the like of the radio base station BS1, the radio base station BS2 and the controller device 11. The storage unit 230 and the wired communication unit 240 are connected to a backhaul network.

The controller 220 has a resource allocation unit 221, a channel quality measurement unit 222, a channel quality comparator 223 and a transmission power controller 224.

The resource allocation unit 221 controls the radio base station BS1 in such a way that the radio base station BS1 allocates the radio resource R1 to the radio terminal UE1 when the radio base station BS1 performs CoMP with the radio terminal UE1.

The channel quality measurement unit 222 measures the channel quality Q1 by using a pilot signal 1 received by the radio base station BS1 from the radio terminal UE1 and also measures the channel quality Q2 by using a pilot signal 2 received by the radio base station BS1 from the radio terminal UE2.

The channel quality comparator 223 compares the channel quality Q1 and the channel quality Q2, which are measured by the channel quality measurement unit 222, and then compares a difference between the channel quality Q1 and the channel quality Q2 with a predetermined value (predetermined threshold).

The resource allocation unit 221 controls the radio base station BS1 in such a way that the radio base station BS1 allocates the radio resource R1 to the radio terminal UE2 instead of the radio terminal UE1 if a predetermined condition indicating that the communication condition between the radio base station BS2 and the radio terminal UE1 is high is satisfied and also if the channel quality Q2 is higher than the channel quality Q1 (hereinafter, described as the channel quality Q1<the channel quality Q2). As a condition for allocating the radio resource R1 to the radio terminal UE2 instead of the radio terminal UE1, the resource allocation unit 221 preferably uses a condition that the channel quality Q2 is higher than the channel quality Q1 by an amount equal to or greater than a predetermined threshold (hereinafter, described as the channel quality Q1<<the channel quality Q2) instead of using the condition that the channel quality Q1<the channel quality Q2. Note that, the allocation of the radio resource R1 to the radio terminal UE2 is performed without taking the procedure to cancel CoMP.

Here, the predetermined condition is that the channel quality Q3 is higher than a predetermined quality (hereinafter, described as the predetermined quality<the channel quality Q3). Note that, the lower limit of the predetermined quality may be a channel quality of a case where the radio terminal UE is capable of demodulating data by using a transmission signal from the radio base station BS2 alone. The predetermined quality may be previously stored in the storage unit 230.

The transmission power controller 224 controls a transmission power for data transmission performed by the radio base station BS1. In a case where the radio resource R1 is allocated to the radio terminal UE2 instead of the radio terminal UE1, the transmission power controller 224 controls the radio base station BS1 in such a way that the radio base station BS1 reduces the transmission power for data transmission to the radio terminal UE2 below the transmission power for data transmission to the radio terminal UE1.

The resource allocation unit 221 controls the radio base station BS1 in such a way that the radio base station BS1 allocates the radio resource R1 to the radio terminal UE1 again if the predetermined condition described above becomes no longer satisfied after the radio resource R1 is allocated to the radio terminal UE2.

As described above, the present invention naturally includes various embodiments which are not described herein. Accordingly, the technical scope of the present invention should be determined only by the matters to define the invention in the scope of claims regarded as appropriate based on the description.

Entire contents of Japanese Patent Application Publication 2009-151663 (filed Jun. 25, 2009) are herein incorporated by reference.

### INDUSTRIAL APPLICABILITY

As described above, with the radio communication system, the radio base station and the radio communication method according to the present invention, it is possible to effectively utilize a radio resource used in coordinated communications. Thus, the radio communication system, the radio base station and the radio communication method are useful in radio communications such as mobile communications.

1. A radio communication system comprising:
a first radio terminal;
a second radio terminal;
a first radio base station configured to allocate, to the first radio terminal, a radio resource specified by a combination of frequency and time; and
a second radio base station configured to allocate, to the first radio terminal, the same radio resource as the radio resource, wherein
the first radio base station and the second radio base station perform coordinated communications with the first radio terminal by using the radio resource, and
the first radio base station allocates the radio resource to the second radio terminal instead of the first radio terminal if a predetermined condition indicating that a communication state between the second radio base station and the first radio terminal is favorable is satisfied and also if a second channel quality between the first radio base station and the second radio terminal is higher than a first channel quality between the first radio base station and the first radio terminal.

2. A radio base station comprising a resource allocation unit configured to allocate a radio resource specified by a combination of frequency and time to a radio terminal, the radio base station configured to perform coordinated communications with the radio terminal together with a different radio base station configured to allocate the same radio resource as the radio resource to the radio terminal, wherein
the resource allocation unit allocates the radio resource to a different radio terminal instead of the radio terminal if a predetermined condition indicating that a communication state between the different radio base station and the radio terminal is favorable is satisfied and also if a second channel quality between the radio base station and the different radio terminal is higher than a first channel quality between the radio base station and the radio terminal.

3. The radio base station according to claim 2, wherein the predetermined condition is that a third channel quality between the different radio base station and the radio terminal is higher than a predetermined quality.

4. The radio base station according to claim 2, wherein
adaptive modulation in which an MCS (Modulation and Coding Scheme) is changeable on the basis of a third channel quality between the different radio base station and the radio terminal is employed for communications between the different radio base station and the radio terminal, and
the predetermined condition is that the MCS used in communications between the different radio base station and the radio terminal is a specific MCS.

5. The radio base station according to claim 4, wherein the specific MCS is an MCS having the highest throughput among all MCSes usable in the adaptive modulation.

6. The radio base station according to claim 4, wherein the specific MCS is an MCS satisfying a throughput required for communications between the different radio base station and the radio terminal among all MCSes usable in the adaptive modulation.

7. The radio base station according to claim 4, wherein, if the MCS to be used in communications between the different radio base station and the radio terminal is previously set at the start of the communications between the different radio base station and the radio terminal, the specific MCS is the set MCS.

8. The radio base station according to claim 2, wherein the resource allocation unit allocates the radio resource to the radio terminal again if the predetermined condition is no longer satisfied.

9. The radio base station according to claim 2, further comprising:
a transmitter configured to perform data transmission by using the radio resource; and
a transmission power controller configured to control a transmission power for data transmission performed by the transmitter, wherein
the resource allocation unit allocates the radio resource to the different radio terminal instead of the radio terminal if the predetermined condition is satisfied, if the second channel quality is higher than the first channel quality, and also if a difference between the first channel quality and the second channel quality is equal to or greater than a predetermined value, and
the transmission power controller reduces a transmission power for data transmission to the different radio terminal below a transmission power for data transmission to the radio terminal if the resource allocation unit allocates the radio resource to the different radio terminal instead of the radio terminal.

10. The radio base station according to claim 2, wherein the resource allocation unit allocates the radio resource to the different radio terminal instead of the radio terminal without taking a procedure to cancel the coordinated communications if the predetermined condition is satisfied and also if the second channel quality is higher than the first channel quality.

11. A radio communication method comprising the steps of:
allocating a radio resource specified by a combination of frequency and time to a first radio terminal by a first radio base station;
allocating the same radio resource as the radio resource to the first radio terminal by a second radio base station;
performing coordinated communications with the first radio terminal by using the radio resource by the first radio base station and the second radio base station; and
allocating the radio resource to the second radio terminal instead of the first radio terminal by the first radio base station if a predetermined condition indicating that a communication state between the second radio base station and the first radio terminal is favorable is satisfied and also if a second channel quality between the first radio base station and the second radio terminal is higher than a first channel quality between the first radio base station and the first radio terminal.
